(19) United States
(12) Patent Application Publication
(10) Pub. No.: US 2016/0357908 A1
(43) Pub. Date: Dec. 8, 2016

(54) COMPUTERIZED SYSTEM AND METHOD FOR CODING MEDICAL RECORDS TO FACILITATE PROVIDER REIMBURSEMENTS

(71) Applicant: Humana Inc., (US)

(72) Inventors: Michael Christner, Sellersburg, IN (US); Denise Thomas, Louisville, KY (US); Diane Lu, Jacksonville, FL (US)

(73) Assignee: HUMANA INC., Louisville, KY (US)

(21) Appl. No.: 13/769,981

(22) Filed: Feb. 19, 2013

Related U.S. Application Data
(60) Provisional application No. 61/599,674, filed on Feb. 16, 2012.

(51) Int. Cl. G06F 19/00

(52) U.S. Cl. CPC G06F 19/322

(57) ABSTRACT

A computerized system and method that allows healthcare providers to update the medical codes in health benefits provider member records. Healthcare providers access and update “suspect conditions” for member records in the database. The health benefits provider receives claims for services provided to its members as well as associated, supporting medical records and documentation for the claims. When processing claims, the health benefits provider enters and tracks the claim and related medical data in a database and identifies one or more “suspect conditions” by coding the member records with standardized medical codes such as HCC codes. The healthcare provider researches “suspect conditions” by reviewing supporting documentation and data and updates the records by affirming or denying conditions. The affirmed condition data for a member population along with revised encounter submissions may further be used in projecting risk scores to the member population and a level of reimbursement for the healthcare provider.

### CROSS-REFERENCE TO RELATED APPLICATIONS

This application claims priority to U.S. Provisional Patent Application Ser. No. 61/599,674, filed Feb. 16, 2012 and titled COMPUTERIZED SYSTEM AND METHOD FOR CODING MEDICAL RECORDS TO FACILITATE PROVIDER REIMBURSEMENTS, the contents of which is incorporated herein by reference.

### BACKGROUND OF THE INVENTION

To facilitate reimbursements to healthcare providers, organizations such as the Center for Medicare Services (CMS) and other health benefits payors require coding of medical records. Coding classifications, such as CMS's hierarchical condition categories (HCC), are used to identify numerous clinical diagnoses or medical conditions relevant to a patient's health. For example, one code identifies chronic pulmonary heart disease while another code identifies a diagnosis of diabetes. The patient record of an individual with multiple chronic health conditions may have multiple codes identifying each of the associated health conditions. For example, an individual who has arthritis may also have osteoporosis and high blood pressure. The patient's electronic record therefore, may have a first code for arthritis, a second code for osteoporosis, and a third code for high blood pressure.

Codes may be identified for medical records by healthcare providers, health benefit providers, and other organizations that may be granted access to a patient's records. Although great care is taken in coding medical records properly, errors and omissions can occur. For example, a healthcare provider may fail to add a code to a patient's record for a newly diagnosed health condition or to provide the correct code for the specific form of a patient's health condition. For example, various codes for renal failure are used to identify specific forms of the disease. To facilitate reimbursement and for other reasons, it is important for medical records to be coded accurately.

Because the information most relevant to an individual's health status typically originates at a healthcare provider that is typically reimbursed by a health benefits provider or other third party payor, medical records received by payors are initially coded according to data received from the healthcare provider. The coding details are typically obtained from the provider's claim or request for reimbursement data. Records are not always coded correctly and when coding errors are discovered, they are often discovered in connection with claims for reimbursement. Because the provider's reimbursement may depend upon proper medical record coding, it is important for providers to have the ability to correct or change codes when questions regarding the coding are raised or when errors are discovered.

Although coding problems may be resolved in various ways such as through direct communications between the healthcare provider and health benefits provider or payor, this approach is neither the most efficient nor effective. The volume of claims generated by healthcare providers and received by health benefits providers is so great that resolving problems by telephone, email, or fax communications is impractical. Even if the individuals involved in the telephone, email, or fax communications reach agreement on the resolution of a coding problem, one or more associated electronic records must be updated. In many instances, it would be much more efficient for the healthcare providers to have access to records that need to be corrected and to allow them to correct them directly.

There is a need for a computerized system and method that allows healthcare providers to access and modify medical record codes for member records of a health benefits provider. In particular, there is a need for a computerized system and method that allows healthcare providers to respond to “suspect conditions” identified in member records for a member population. There is a need for a computerized system and method that allows healthcare providers to enter and correct codes for medical records stored at a health benefits provider and used for reimbursement of services.

### SUMMARY OF THE INVENTION

The present disclosure is directed to a web-based tool that grants healthcare providers the ability to make real-time updates to the medical codes in health benefits provider member records. In an example embodiment, healthcare providers access and update “suspect conditions” in a health benefits provider's Suspect Tracking And Reporting (STAR) database. The health benefits provider receives claims for services provided to its members as well as associated, supporting medical records and documentation for the claims. In connection with processing claims for reimbursement, the health benefits provider enters and tracks the claim and related medical data in a database and identifies one or more “suspect conditions” by coding the member records with standardized medical codes such as HCC codes. The healthcare provider is provided with access to the database records and permitted to update records while researching “suspect conditions” in supporting documentation and data. The healthcare provider may review written reports and other relevant data to affirm or deny the “suspected condition” identified in a member record. As a result, healthcare providers and the health benefits provider are assured that all data associated with a patient's medical record is as current and accurate as possible. The affirmed condition data for a member population along with revised encounter submissions may further be used in projecting risk scores to the population and a level of reimbursement for the healthcare provider.

### BRIEF DESCRIPTION OF THE DRAWINGS

FIG. 1 is a sample STARs application access page according to an example embodiment;

FIGS. 2A and 2B are sample member list pages according to an example embodiment;

FIG. 3 is a sample “condition status details” page according to an example embodiment;

FIGS. 4A-4C are sample “affirm condition” pages according to an example embodiment;

FIG. 5 is a sample “condition status details” page according to an example embodiment;

FIGS. 6A and 6B are sample “condition status detail” pages according to an example embodiment;

FIG. 7 is a sample “no conditions” page according to an example embodiment;

FIGS. 8A and 8B are sample “add condition” pages according to an example embodiment;

FIG. 9 is a sample “member condition” profile pages according to an example embodiment;

FIGS. 10A-10D are sample “provider affirm condition” pages according to an example embodiment;

FIG. 11 is a sample activity report according to an example embodiment;

FIG. 12 is a sample condition status report page according to an example embodiment;

FIGS. 13A and 13B are sample member listing report pages according to an example embodiment;

FIG. 14 is a sample “member not updated” report page according to an example embodiment; and

FIG. 15 is a sample “unresolved level one conditions” report page according to an example embodiment.

### DETAILED DESCRIPTION

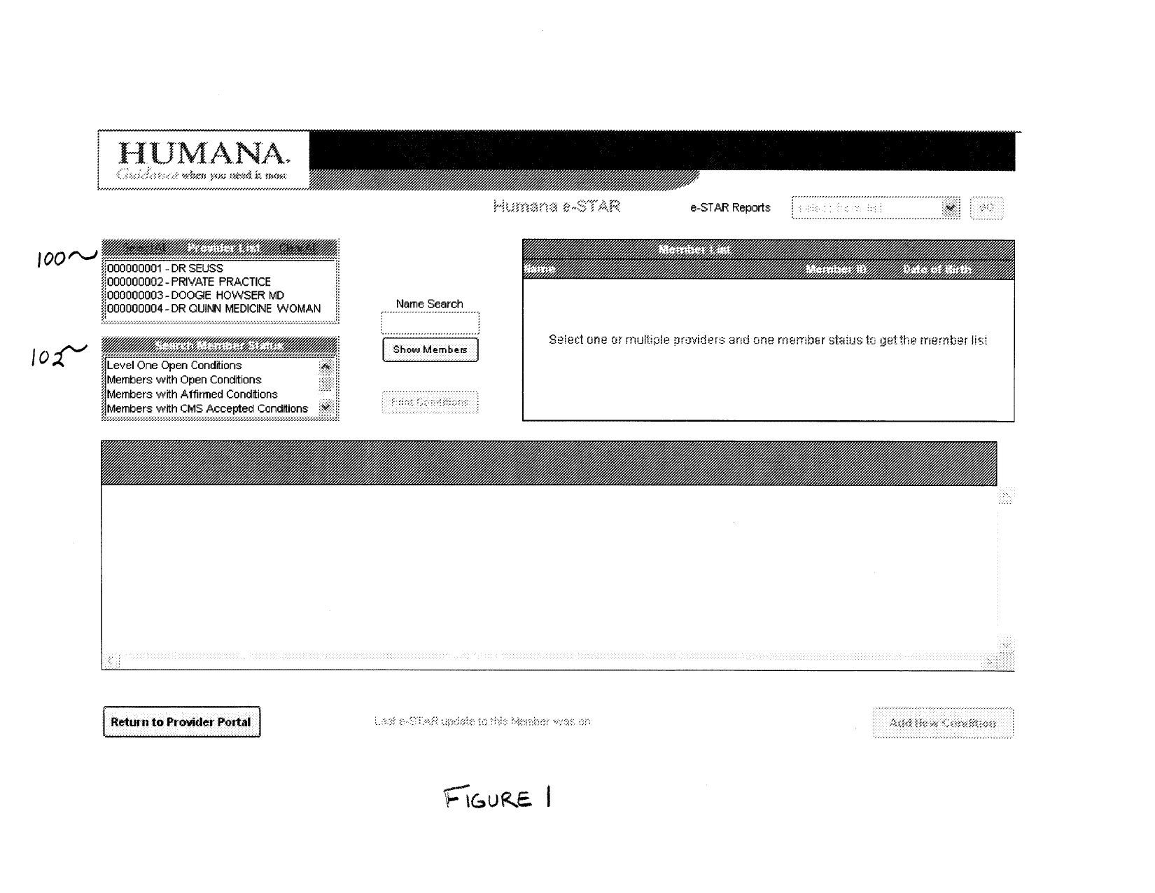

Referring to FIG. 1, a sample STAR application access page according to an example embodiment is shown. The page comprises “provider” 100 and “member status” 102 options. The provider list identifies individual healthcare providers or healthcare facilities affiliated with the user's login identity. The user may select one or more providers from the list. The member status list comprises a plurality of member conditions. In an example embodiment, the status conditions are:

TABLE 1
Member Status Conditions

| | |
|---|---|
| Level One Open | Conditions more likely to be seen in a provider |
| Conditions | office setting than a hospital setting. Example |
| | “level one” Conditions are listed in Table 2. |
| Open Conditions | List of members having at least one open suspect |
| | condition, regardless of whether the open |
| | condition is a “level one” condition. All of a |
| | member's conditions are displayed as long as |
| | that member has at least one open condition. |
| Affirmed | List of members having at least one affirmed |
| Conditions | condition. All of a member's conditions are |
| | displayed as long as that member has at least |
| | one affirmed condition. |
| “CMS accepted” | List of members having at least one CMS accepted |
| Conditions | condition. All of a member's conditions are |
| | displayed as long as that member has at least |
| | one CMS accepted condition. |
| Conditions | List of members having at least one condition, |
| | regardless of the status of that condition |
| | (Open, Affirmed, “CMS accepted”, etc.). |
| No Conditions | List of members that do not have any conditions. |

TABLE 2
Example “Level One” Conditions

| HCC | DESCRIPTION |
|---|---|
| 10 | BREAST, PROSTATE, COLORECTAL AND |
| | OTHER CANCERS AND TUMORS |
| 15 | DIABETES WITH RENAL OR PERIPHERAL |
| | CIRCULATORY MANIFESTATION |
| 16 | DIABETES WITH NEUROLOGIC OR OTHER |
| | SPECIFIED MANIFESTATION |
| 18 | DIABETES WITH OPHTHALMOLOGIC OR |
| | UNSPECIFIED MANIFESTATION |
| 19 | DIABETES WITHOUT COMPLICATION |
| 27 | CHRONIC HEPATITIS |
| 38 | RHEUMATOID ARTHRITIS AND INFLAMMATORY |
| | CONNECTIVE TISSUE DISEASE |
| 68 | PARAPLEGIA |
| 71 | POLYNEUROPATHY |
| 73 | PARKINSON'S AND HUNTINGTON'S |
| | DISEASES |
| 74 | SEIZURE DISORDERS AND CONVULSIONS |
| 80 | CONGESTIVE HEART FAILURE |
| 83 | ANGINA PECTORIS/OLD MYOCARDIAL |
| | INFARCTION |
| 92 | SPECIFIED HEART ARRHYTHMIAS |
| 100 | HEMIPLEGIA/HEMIPARESIS |
| 105 | VASCULAR DISEASE |
| 108 | CHRONIC OBSTRUCTIVE PULMONARY |
| | DISEASE |
| 130 | DIALYSIS STATUS |
| 131 | RENAL FAILURE |
| 132 | NEPHRITIS |
| 149 | CHRONIC ULCER OF SKIN, EXCEPT |
| | DECUBITUS |
| 176 | ARTIFICIAL OPENINGS FOR FEEDING |
| | OR ELIMINATION |
| 177 | AMPUTATION STATUS, LOWER LIMB |
| | AMPUTATION COMPLICATIONS |

Selection of the “level one open conditions” search criteria returns a list of members that have at least one open “level one” condition. In addition to displaying open “level one” conditions, the member condition profile also includes all “CMS accepted” conditions, along with all “level one” conditions regardless of suspect status. In an example embodiment, all of a member's conditions are not displayed in the “level one” search results. Only those conditions that are “level one” conditions or “CMS accepted” conditions appear in the member condition profile.

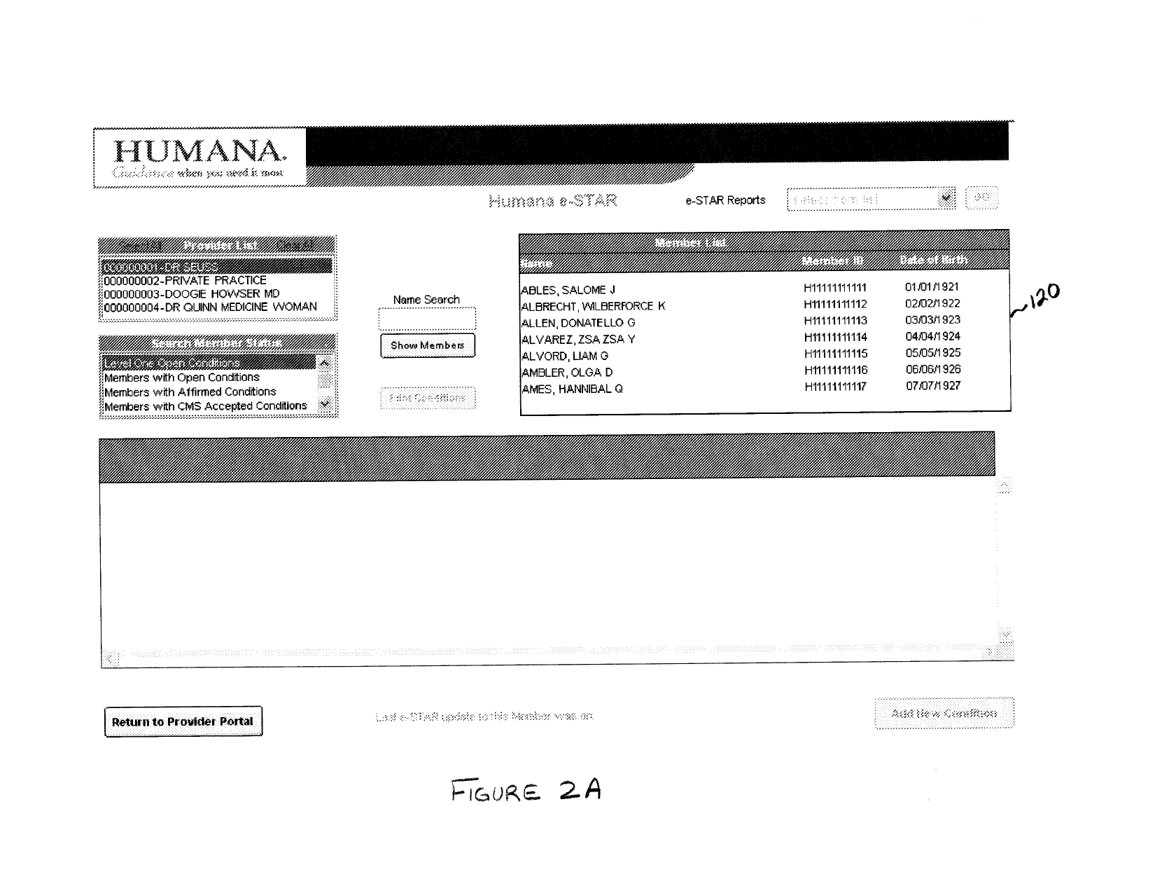

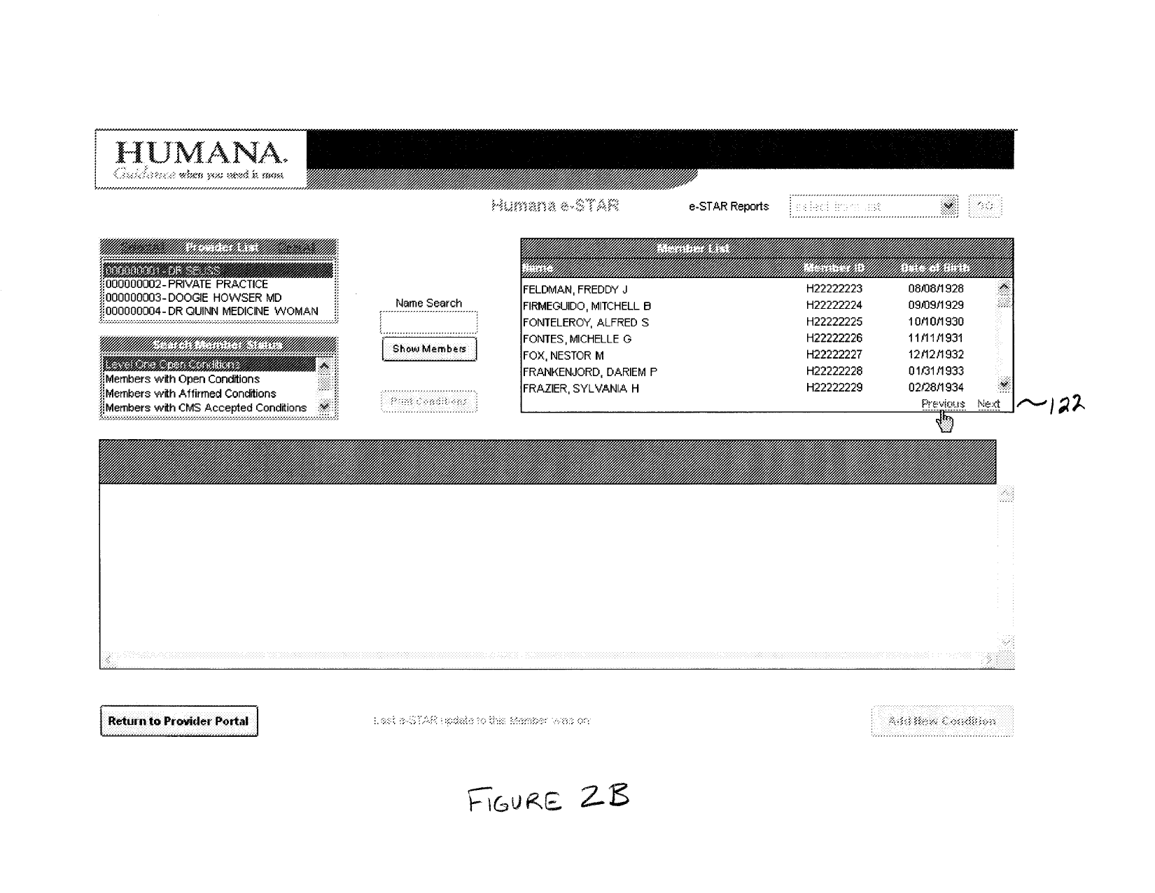

Referring to FIGS. 2A and 2B, a sample “member list” page according to an example embodiment is shown. Referring to FIG. 2A, identifying data for members meeting the selection criteria is displayed in a window 120. Referring to FIG. 2B, the user may scroll through the list of member names by selecting a “previous” or “next” option 122.

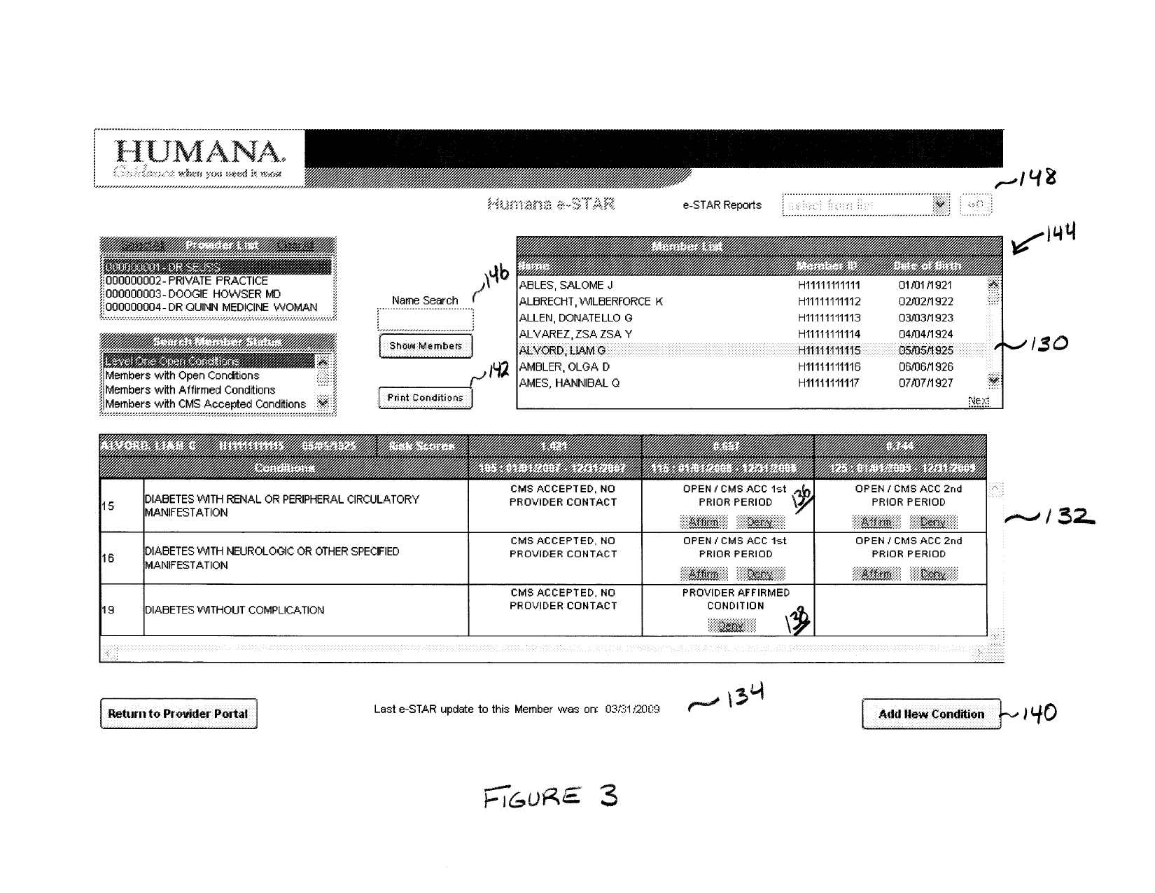

Referring to FIG. 3, a sample “condition status details” page according to an example embodiment is shown. The user may view the condition status details for a specific member by initiating a “left click” option on the member's name 130. The member's condition profile is displayed 132, listing all conditions for that member according to the search member status option used to initiate the search. The member condition profile comprises the following details: member name; member identifier; member's date of birth; risk scores for three CMS periods; HCC; condition description; condition status for 2^{nd} prior year CMS period; condition status for 1^{st} prior year CMS period; and condition status for current CMS period. Once a member has been selected, the message at the bottom of the screen (“Last STAR update . . . ”) 134 identifies the last date that a condition has been added, affirmed, or denied in the STAR database for that member. If the member's prior period or current period conditions have not been updated in the STAR database, the message is “N/A” instead of a date.

Based upon information contained in the medical record there are several possible actions the user can perform:

TABLE 3
User Options

| Action | Description |
|---|---|
| Affirm or Deny | HCC Code - 15 Diabetes With Renal |
| 136 | or Peripheral Circulatory Manifestation - |
| | Affirm or Deny Condition (Year 115 |
| | and/or Year 125). |
| Deny | HCC Code - 19 Diabetes Without |
| 138 | Complication - Deny Condition (Year 115) |
| Add New Condition | Identify a new condition for the member |
| 140 | |
| Print Conditions | Print member's condition profile grid |
| 142 | |
| Select New Member | Select a new member from the member list |
| 144 | |
| Search for a New | Search for a different member by last name |
| Member 146 | |
| Create Reports | Create several types of reports |
| 148 | |

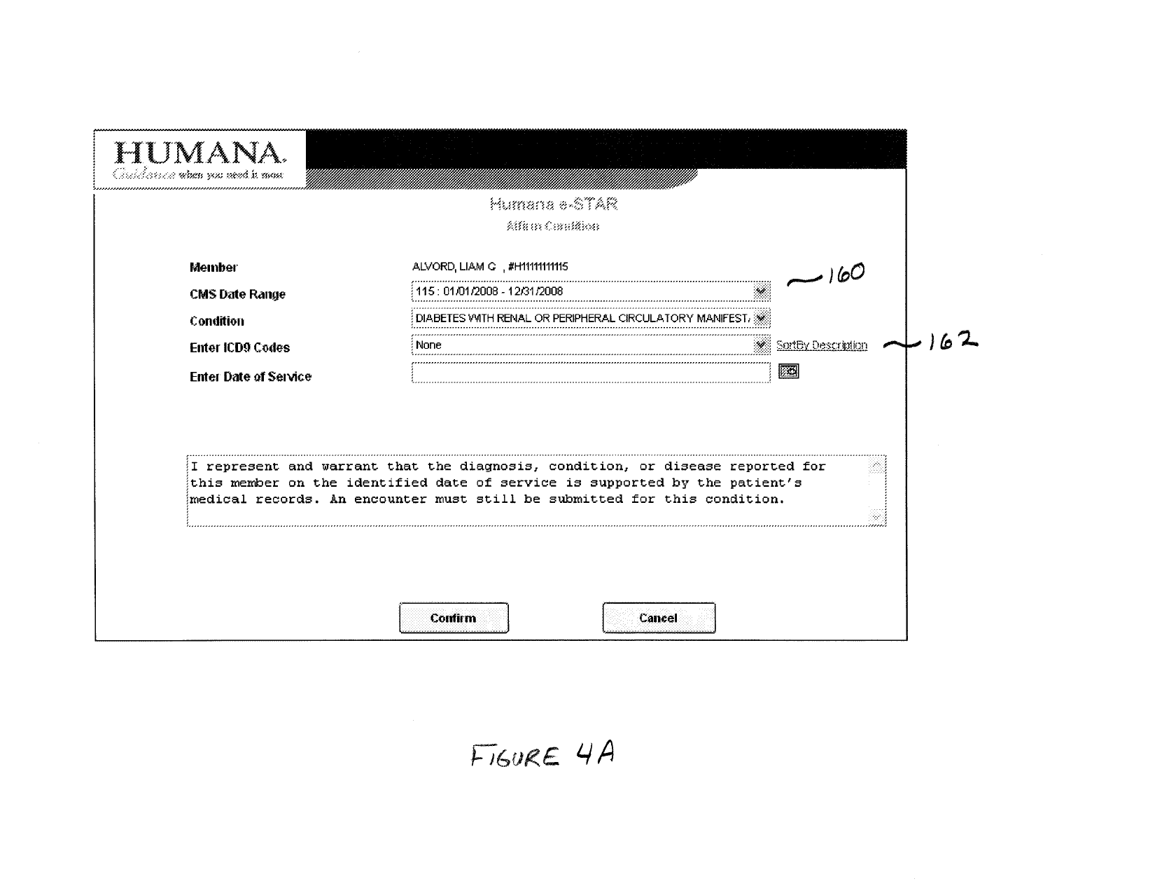

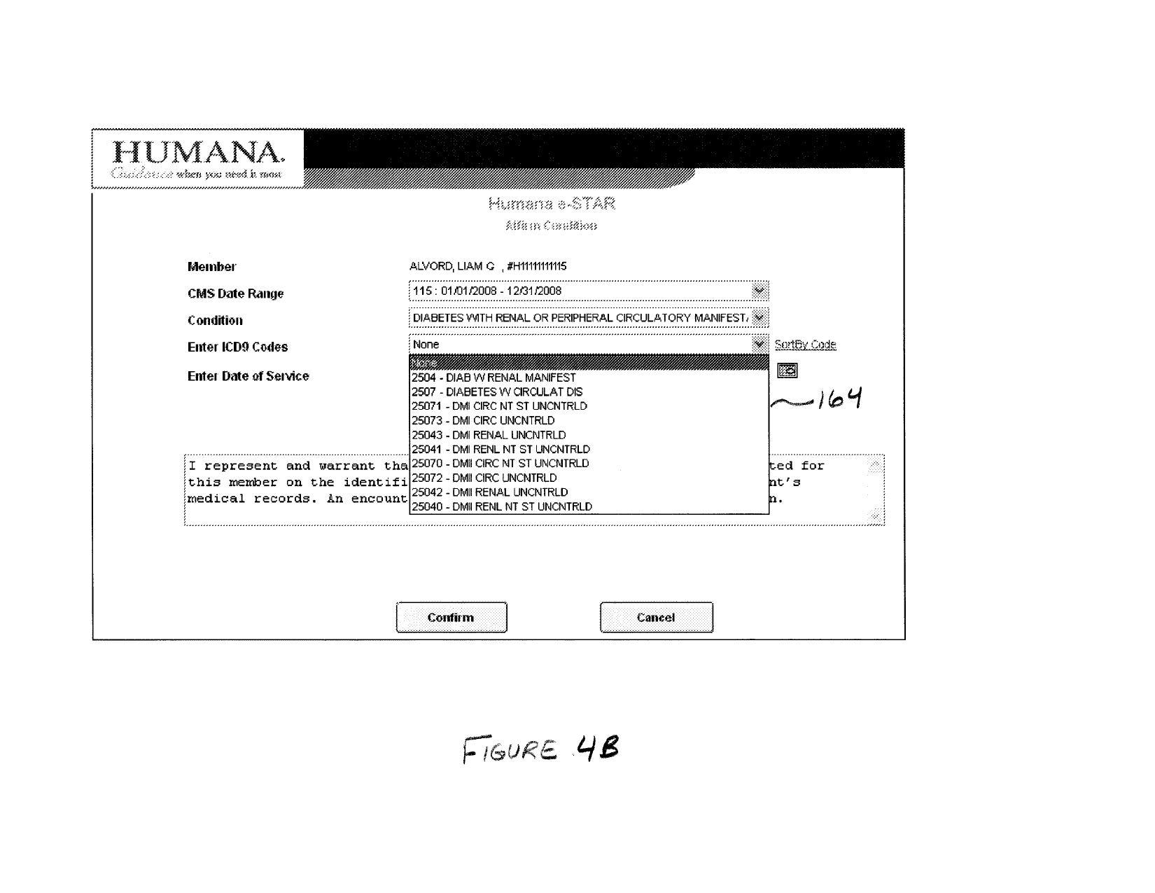

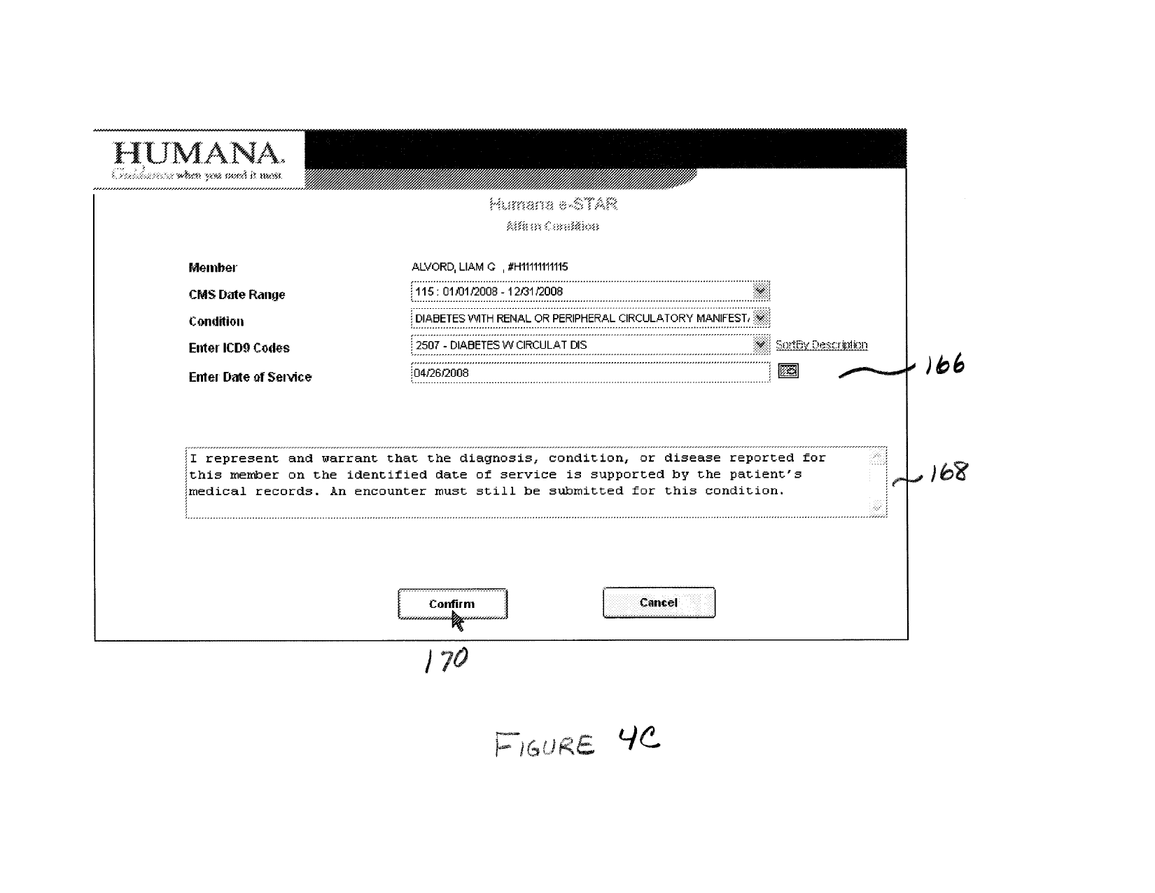

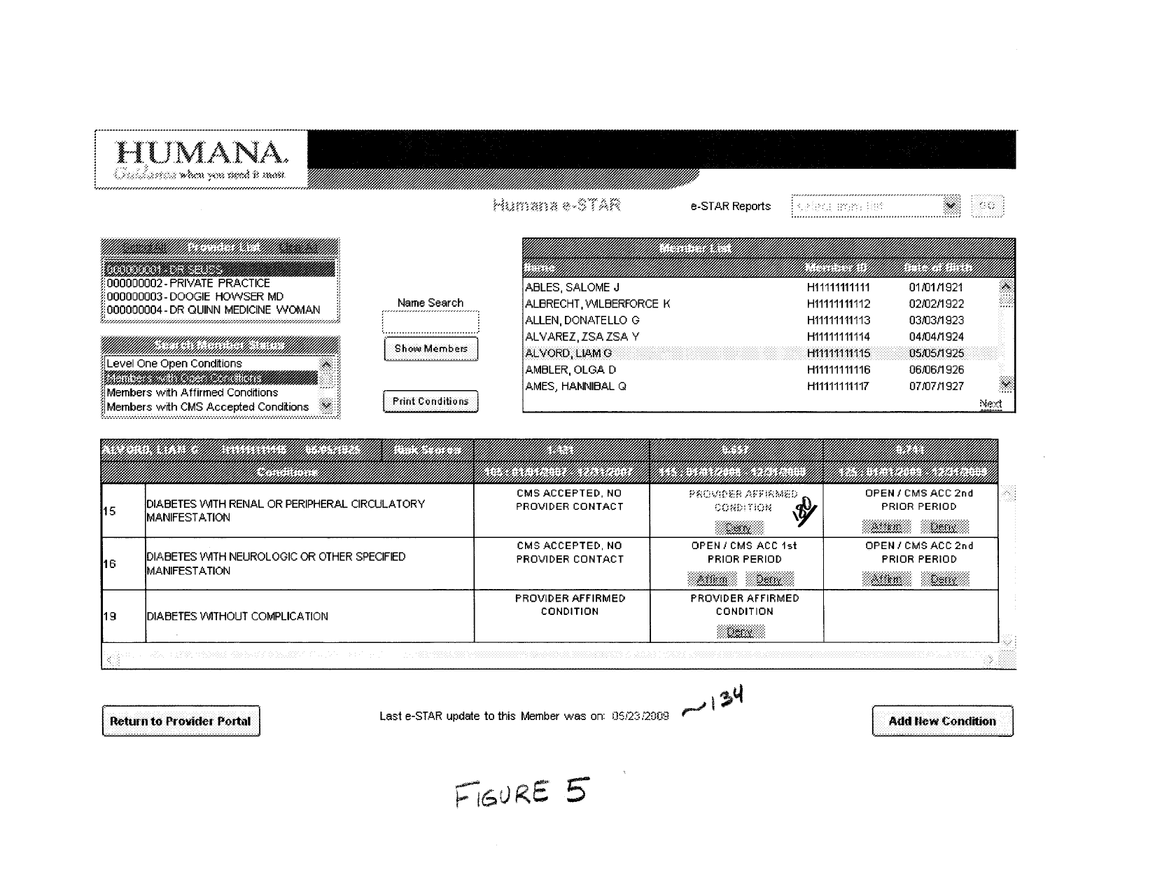

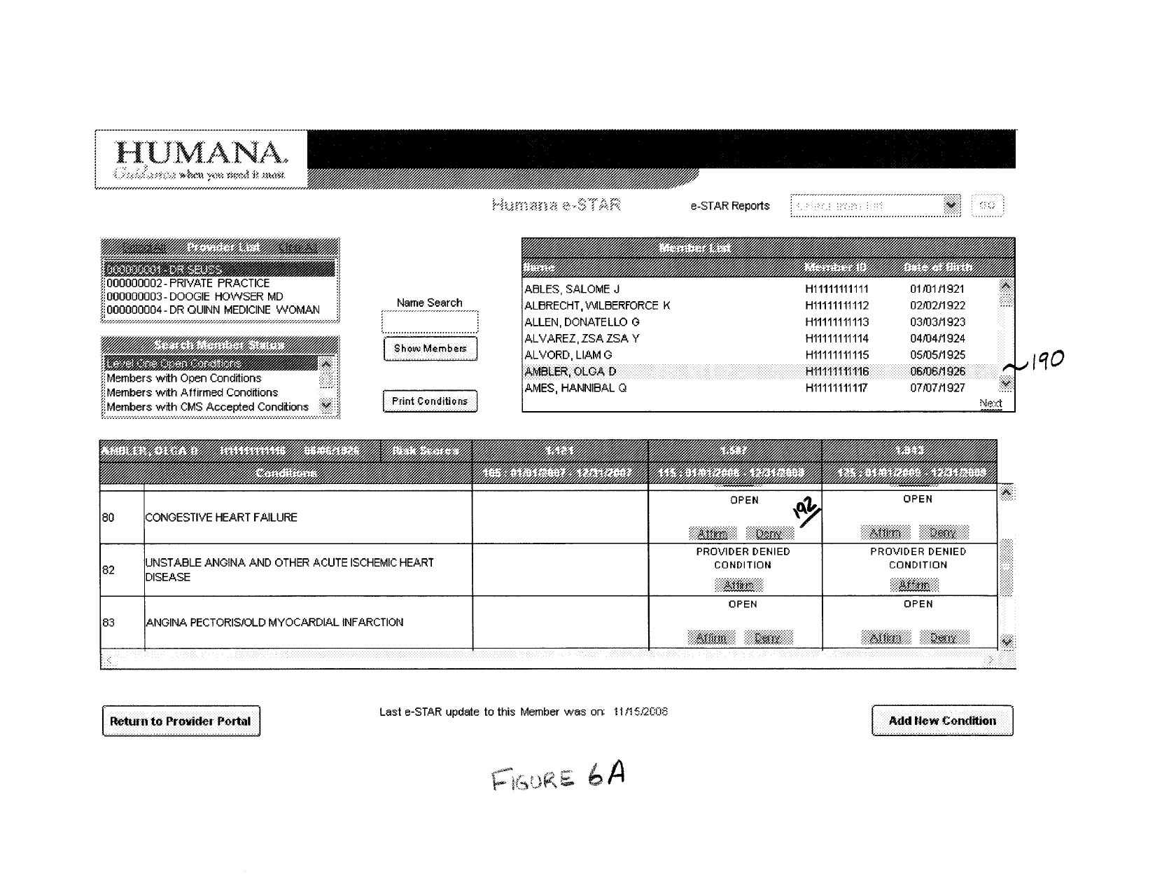

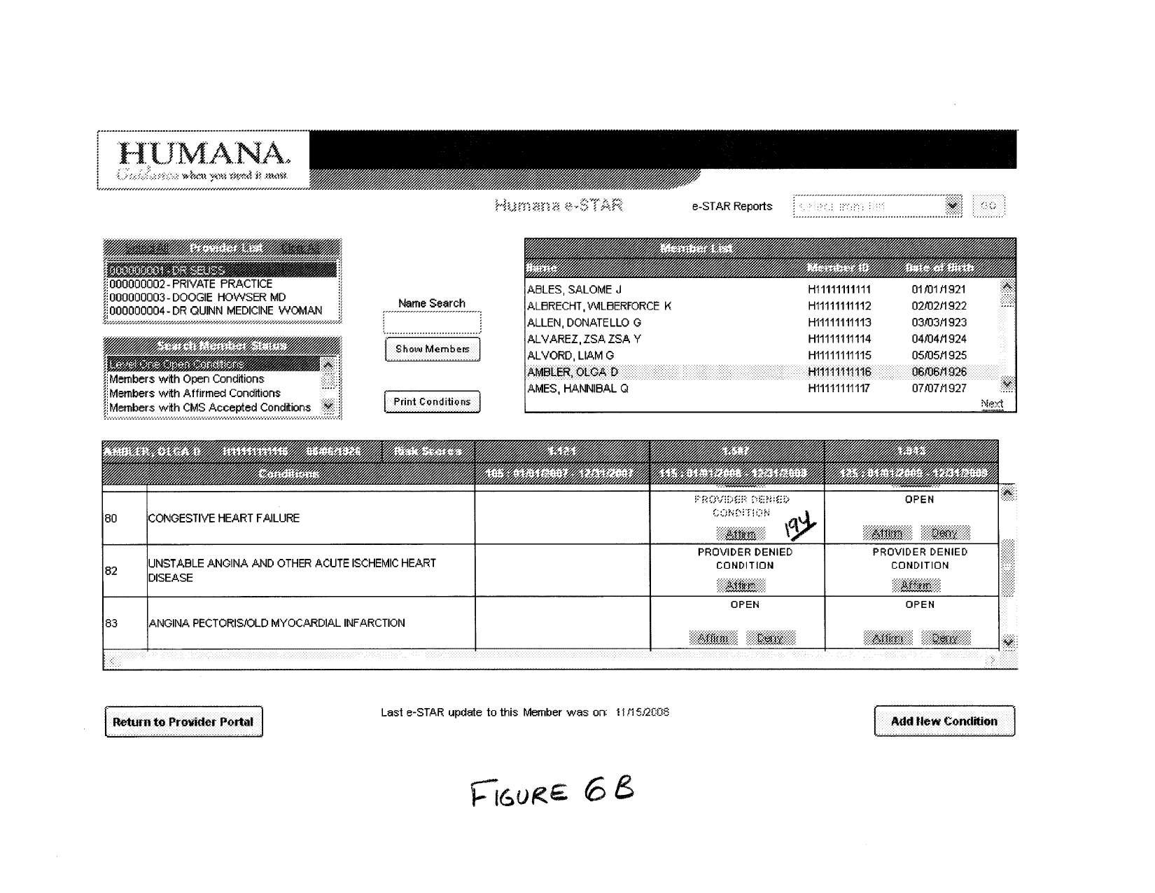

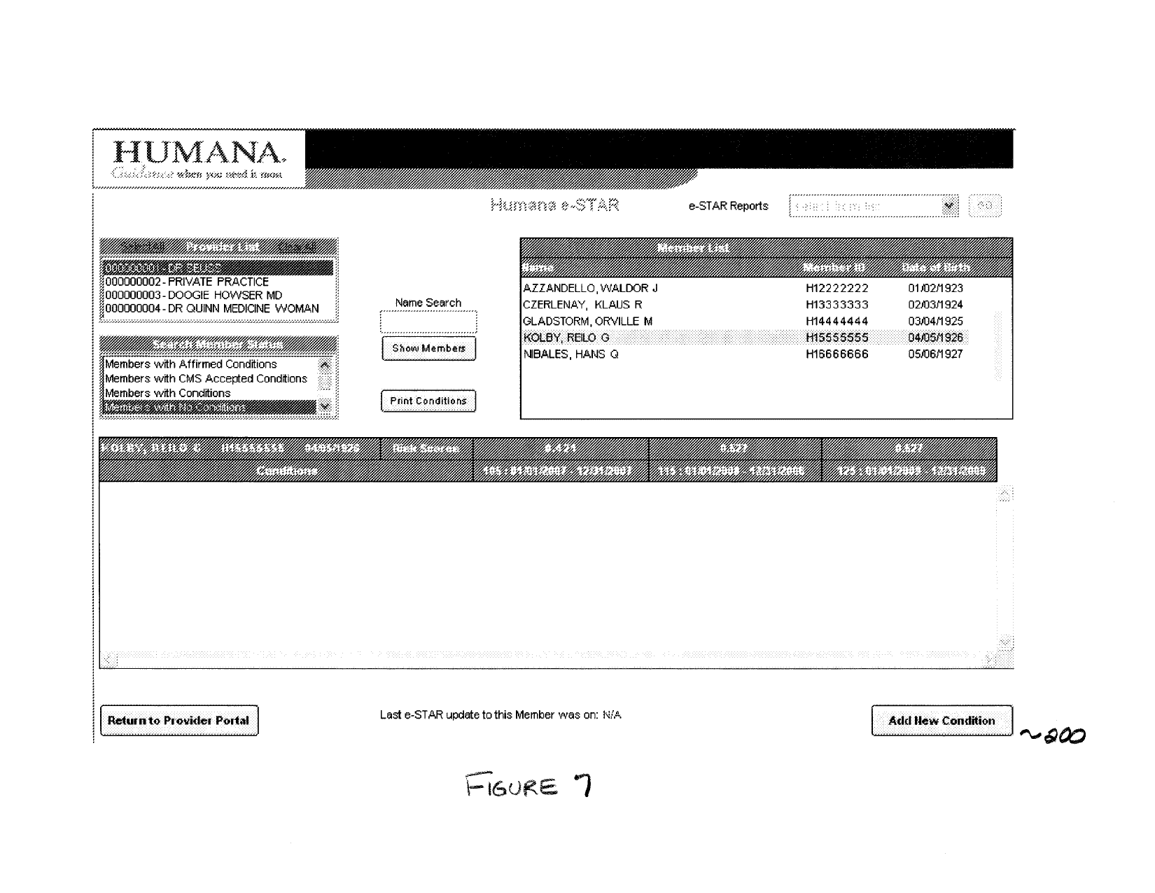

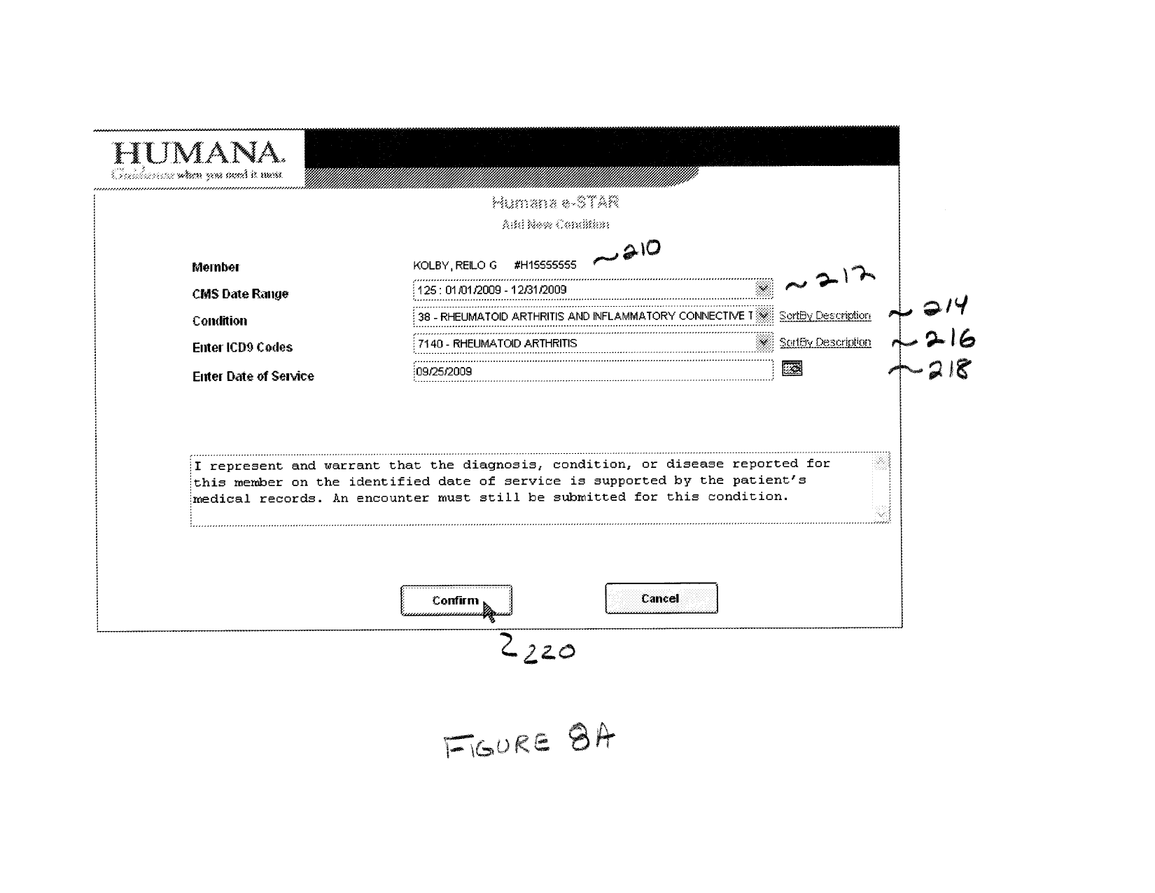

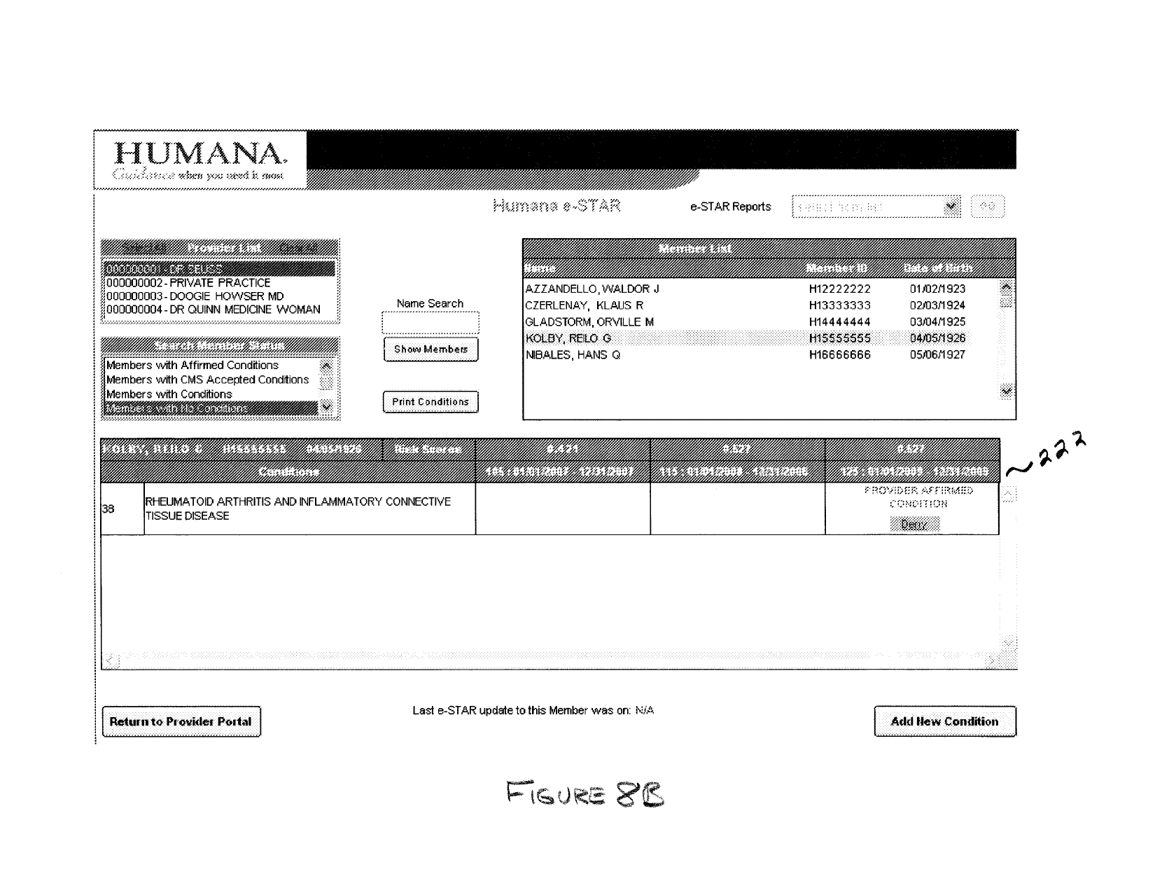

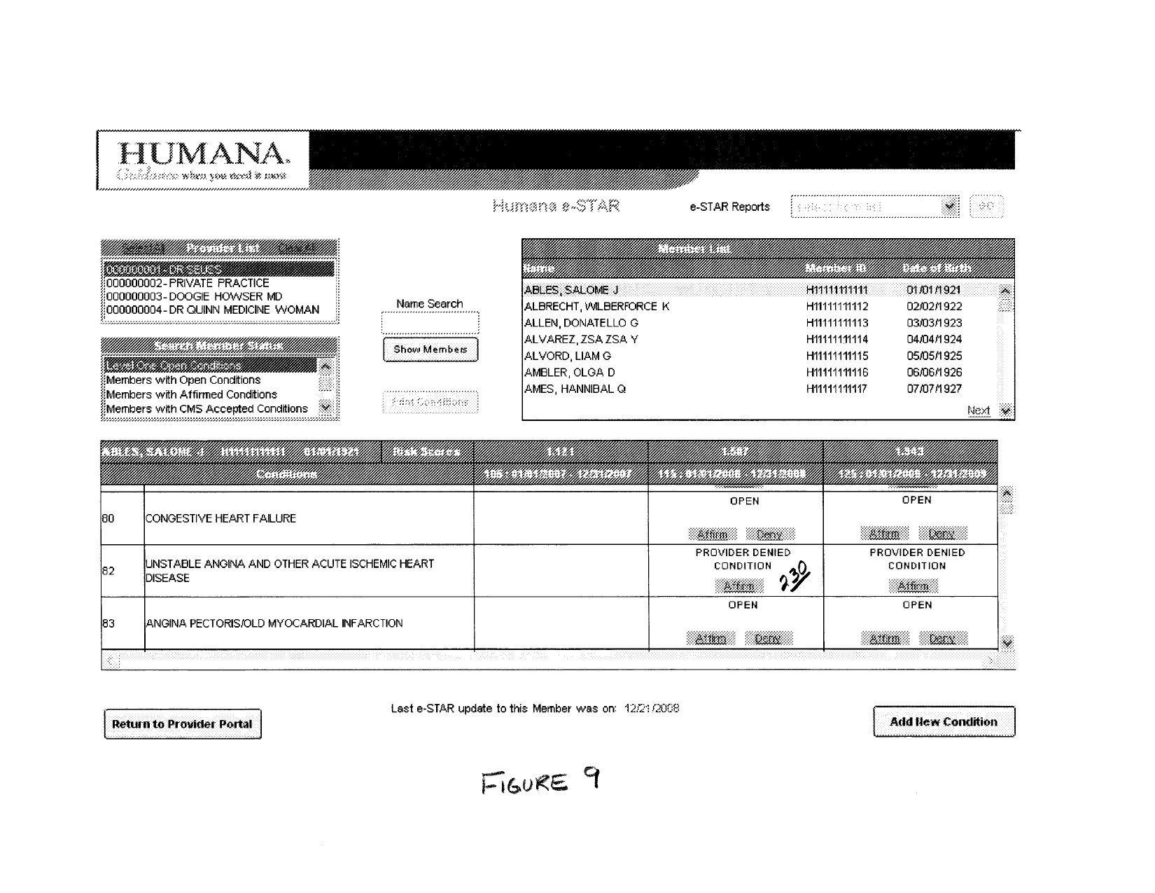

The details of the example medical record indicates that the member has HCC 15—Diabetes With Renal or Peripheral Circulatory Manifestation. To “affirm” this condition for year 115, the user left clicks on the “affirm” word link for HCC 115 in the CMS Date Range 115 column of the member's condition profile grid 136. In response to the user action, an “affirm condition” page as shown in FIG. 4A is displayed. The page is populated with member details 160. The user is further presented with an option to enter an appropriate ICD-9 code associated with the displayed condition 162. The user may select from a list of ICD9 Codes in a drop down list 164 as illustrated in FIG. 4B. The drop down list comprises all applicable ICD9 codes and their descriptions. ICD9 codes associated with the condition displayed on the “affirm condition” page appear in the ICD9 code drop down list. Referring to FIG. 4C, the user may further enter an applicable date of service 166. After reading the message box 168 (confirming that documentation for the condition is found in the member's medical record and acknowledging that an encounter must be submitted for the condition), the user may select the “confirm” option 170. Selection of the “confirm” option updates the member's condition status and returns the user to the member condition profile page. If desired, the user can cancel the transaction by selecting the cancel option. When the cancel option is selected, the database is not updated and the member condition profile page is presented.

Referring to FIG. 5, a sample “condition status details” page (following a user's affirmation of condition code 15) according to an example embodiment is shown. The page shows that in Year 115, Condition Code 15—Diabetes With Renal or Peripheral Circulatory Manifestation is a “provider affirmed condition” 180. The database update message at the bottom of the screen 134 (“Last STAR update to this member was on: 03/31/2009”) is not updated even though a condition has been updated for this member. The message is not refreshed real-time. To see the updated message, the user exits the STAR session, then logs back into the STAR application. After initiating another STAR session, the user selects the appropriate search member status criteria to retrieve the updated member data. When the member is selected from the member list, the message at the bottom of the screen displays the current date at the last STAR database update date.

Referring to FIG. 6A, a sample “condition status details” page (prior to a user's denial of condition code 80) according to an example embodiment is shown. For a selected member 190, a provider may deny a condition based on the absence of supporting documentation in the member's medical record. In the example, assuming the member's medical record contains no documentation to support the open condition “HCC 80—Congestive Heart Failure,” the user may deny this condition for Year 115 by selecting the “deny” word link 192 for HCC 80 in the CMS Date Range 115 column of the member's condition profile grid. As shown in FIG. 6B, this action refreshes the member condition profile screen to indicate that in Year 115, Condition Code 80—Congestive Heart Failure is a “provider denied condition” 194.

Referring to FIG. 7, a sample “no conditions” page according to an example embodiment is shown. If, upon reviewing a member's medical record, the user discovers documentation supporting a condition not displayed for a member, the new condition may be added to the member's condition profile. Conditions may be added for members found in any of the search member status search options. The user selects the “add new condition” option 200 to add an applicable condition.

Referring to FIG. 8A, an “add condition” page according to an example embodiment is shown. The user may add a new condition for a selected member 210 based upon supporting documentation found in the member's medical record. To add a new HCC condition, the user selects from drop down lists a CMS date range 212, a condition 214, and a related ICD9 code 216. The user further provides a date of service 218. After reviewing the confirmation message, the user may select the confirm option 220 to add the new condition. Referring to FIG. 8B, a sample “provider affirmed new condition” page according to an example embodiment is shown. In the update page, the new condition appears along with the “provider affirmed condition” indicator 222.

A user may also change a “provider affirmed condition” and “provider denied condition” if a condition that is displayed is incorrect based on either documentation found in the member's medical chart, or the absence of supporting documentation. Referring to FIG. 9, a sample “member condition” profile page with an incorrect condition status is shown. A review of the member's medical record may confirm the member had unstable Angina and Other Acute Ischemic Heart Disease during Year 115 while the member condition profile indicates the condition is a “provider denied condition” 230. The user may select the “affirm” option 230 to change the condition status.

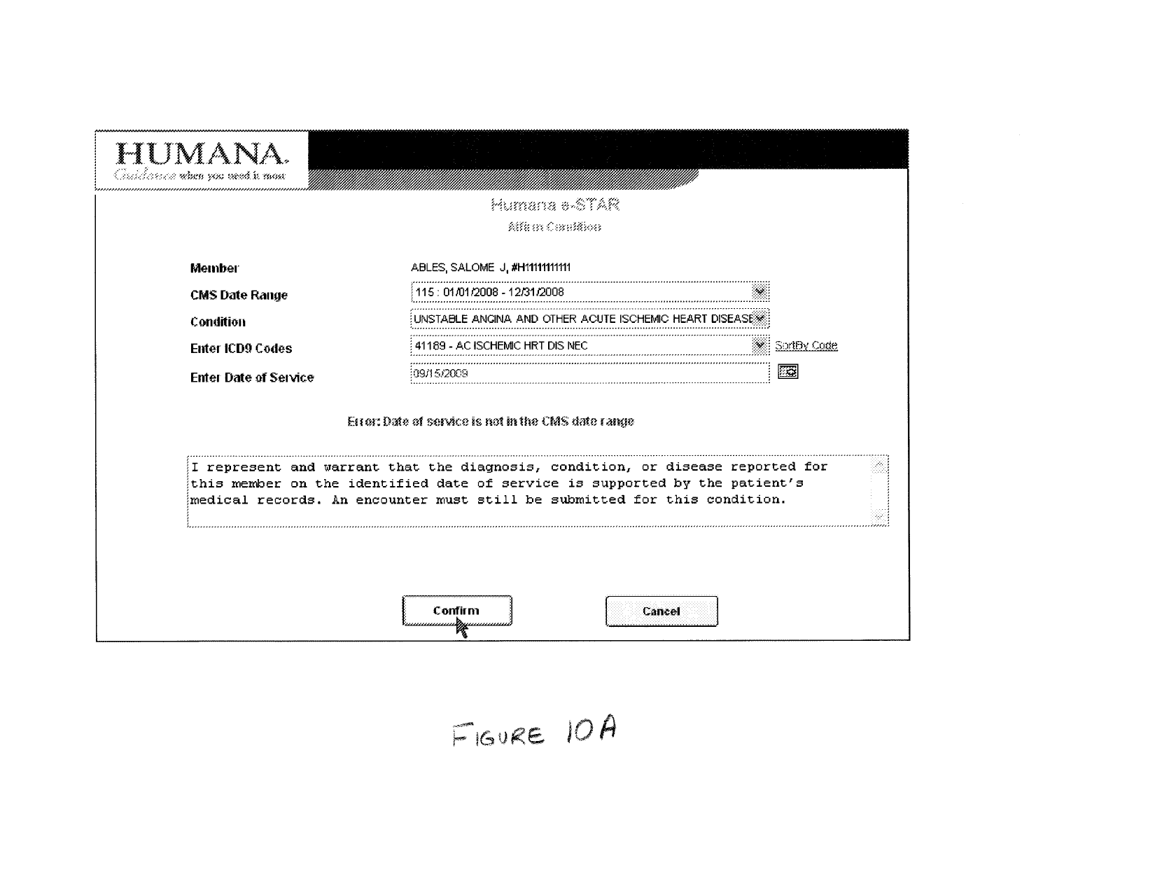

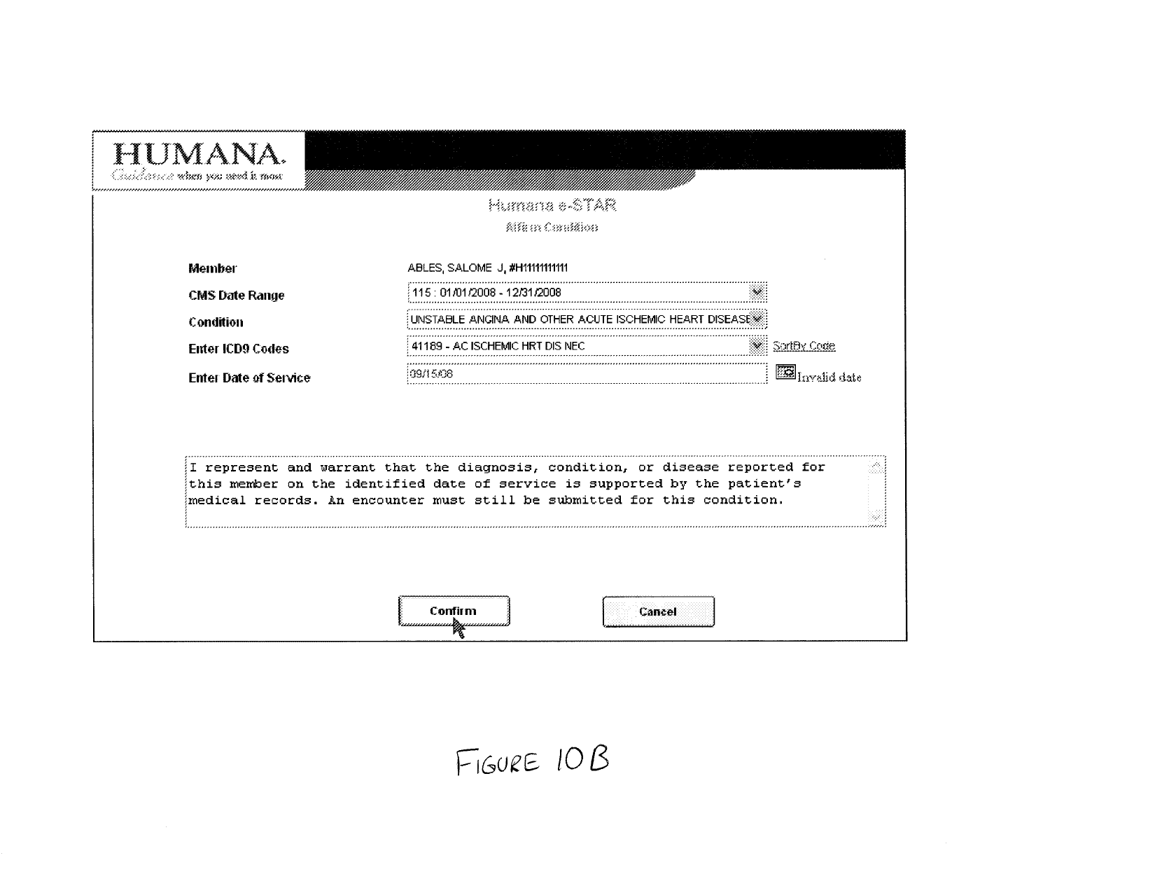

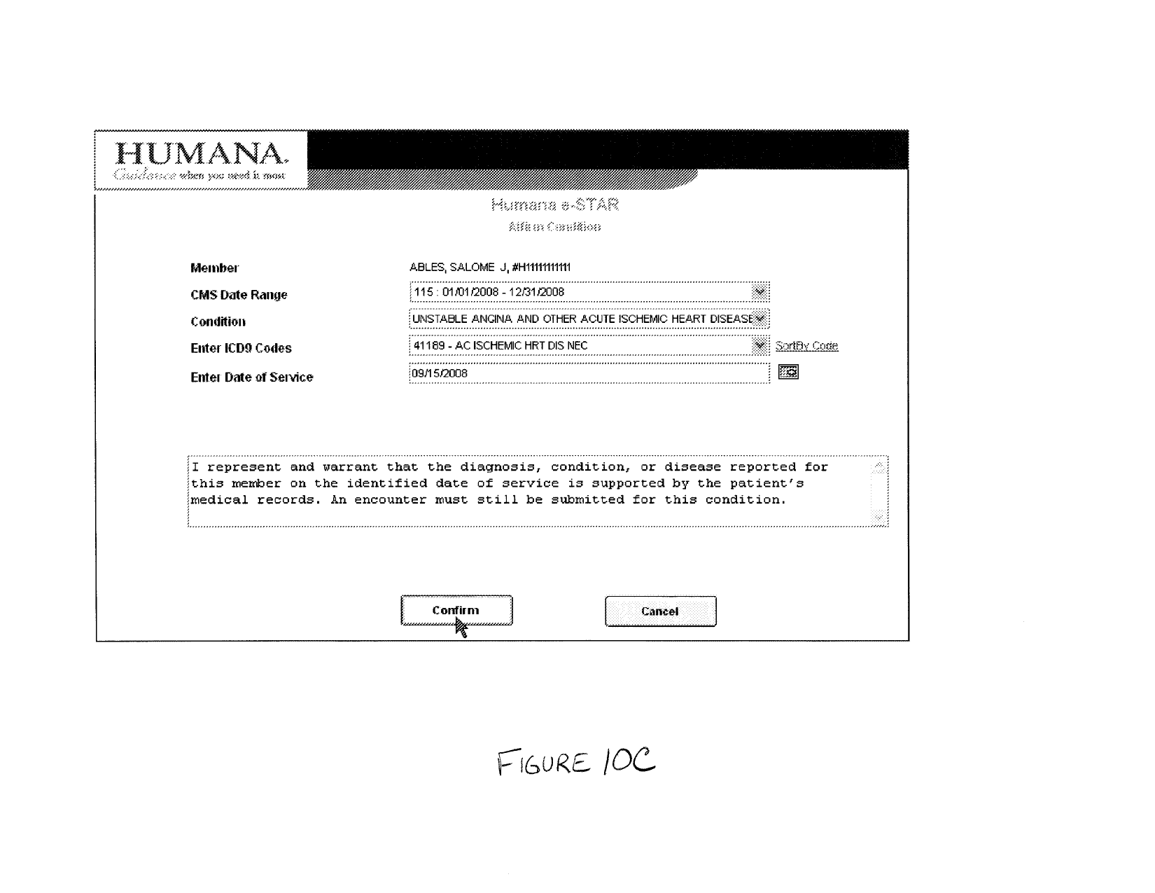

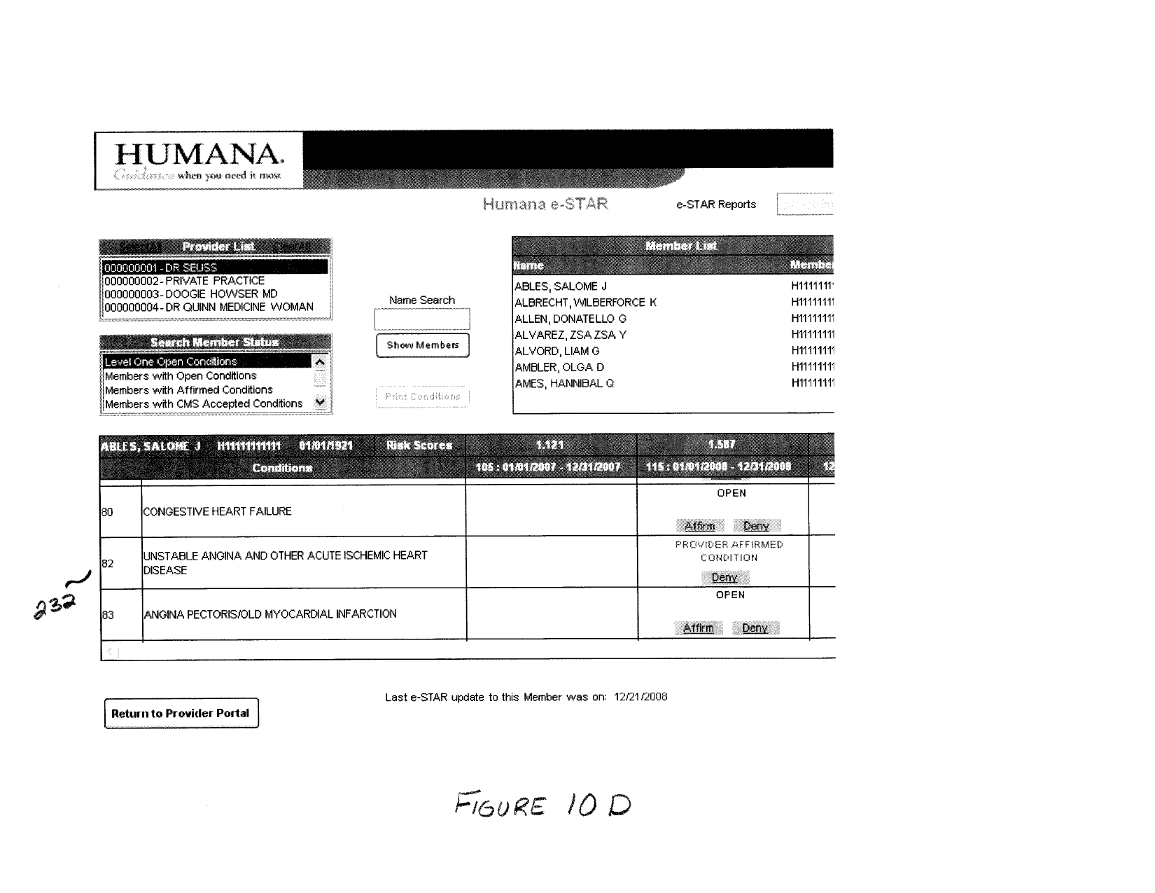

Referring to FIGS. 10A-10C, sample “provider affirm condition” pages according to an example embodiment are shown. The user may change the condition status to provider affirmed by providing the input requested on the page. The STAR application notifies the user if the input (e.g., date of service) is outside an expected range for the specified CMS year or if it is entered incorrectly. When the user is finished providing the requested data, selection of the “confirm” option causes the member's condition profiled to be refreshed with the appropriate indicator 232 as shown in FIG. 10D. As shown in FIG. 10D, the member's condition profile shows HCC 82 is a “provider affirmed condition” 232.

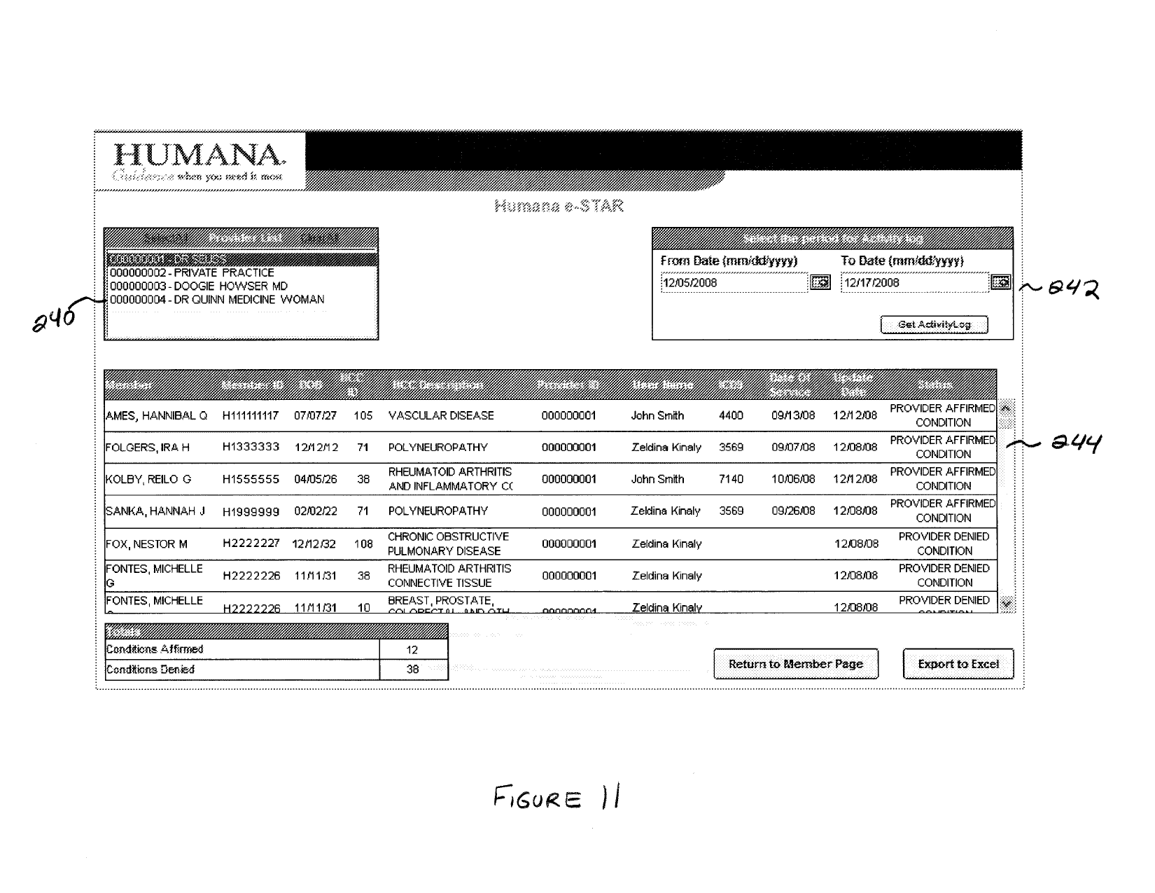

Report options include an activity log report that displays all activity (conditions which have been updated in the STAR database) for the provider(s) selected in the provider list window 240. The user may specify date parameters by selecting “From and To” dates 242. Referring to FIG. 11, a sample activity report page according to an example embodiment is shown. The report details 244 comprise the following:

TABLE 4
Activity Log Details

| | |
|---|---|
| Member Name | (displays members who have been updated in |
| | the STAR database during the period for |
| | which the report was generated) |
| Member ID | unique member identifier |
| DOB | member date of birth |
| HCC ID | condition updated in the STAR database for |
| | this member |
| HCC | condition description for condition updated |
| Description | in the STAR database |
| Provider ID | primary care physician associated with the |
| | member that was updated |
| User Name | STAR application user that performed the |
| | update to this member |
| ICD9 | diagnosis detail applicable to those conditions |
| | that were “affirmed” during the period for |
| | which the report was generated |
| Date of | applicable to those conditions that were “affirmed” |
| Service | during the period for which the report was generated |
| Update Date | date that the condition was updated in the STAR database |
| Status | action that was performed for the updated condition |

The activity log also displays a summary of total “affirmed conditions” and total “denied conditions” updated during the period for which the report was generated.

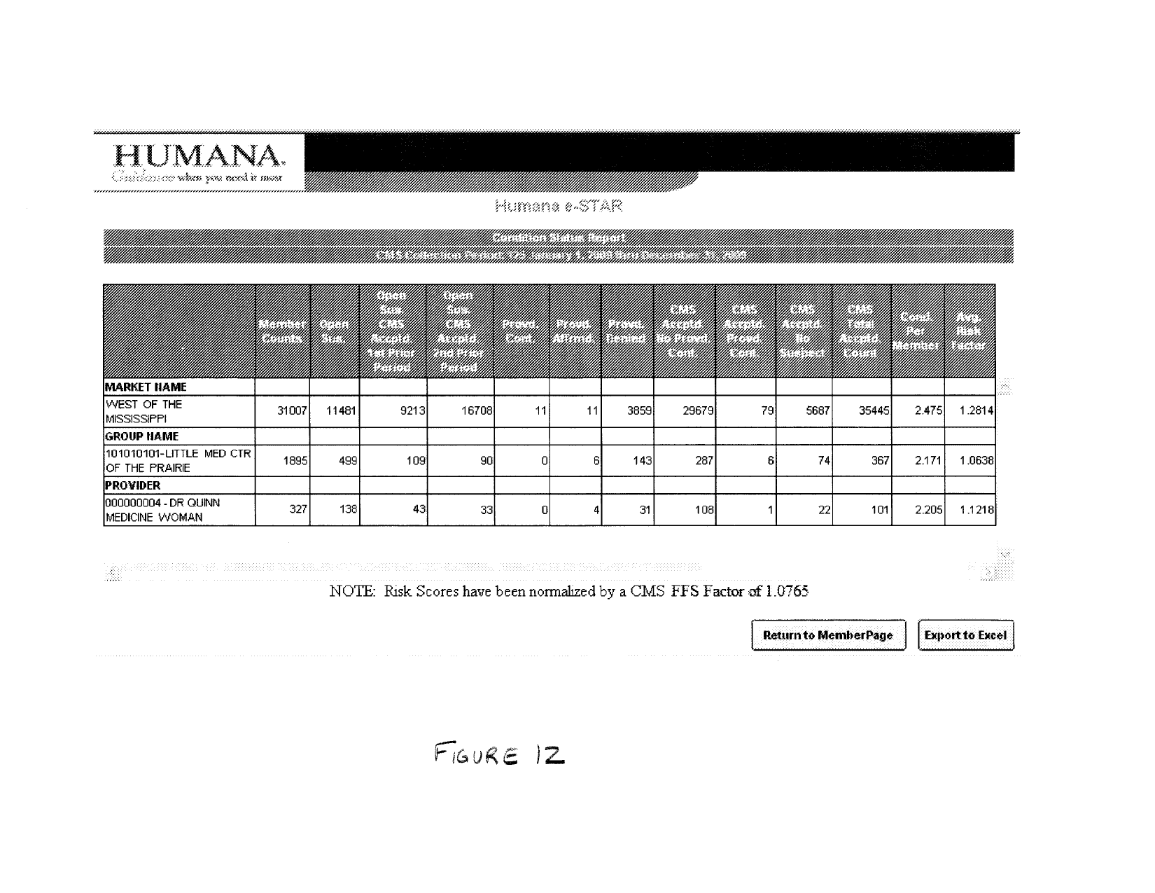

Referring to FIG. 12, a sample condition status report page according to an example embodiment is shown. This report calculates and displays current condition status summary information and calculates an average risk score per member at three different levels: individual provider, provider group, and market. The condition status report displays information associated with the provider(s) selected in the provider list window on the main STAR application screen. Summary information displayed on the condition status report is as follows:

TABLE 5
Condition Status Report Details

| | |
|---|---|
| Member Counts | total number of membership associated with |
| | provider(s) |
| Open Suspects | total suspects identified during the current |
| | period |
| Open CMS | total suspects that were “CMS accepted” |
| Accptd. 1st | conditions from prior period |
| Prior Period | |
| Open CMS | total suspects that were “CMS accepted” |
| Accptd. 2nd | conditions from two prior periods |
| Prior Period | |
| Provd. Cont. | total suspects for which the provider has |
| | been contacted, but provider has neither |
| | affirmed or denied the condition |
| Provd. Affirmd. | total suspects the provider has affirmed - |
| | no supporting claim or encounter has yet |
| | been received |
| Provd. Denied | total suspects the provider has denied |
| CMS Accptd. | total conditions that have been accepted by |
| No Provd. Cont. | CMS; provider was never contacted |
| CMS Accptd | total conditions that have been accepted by |
| Provd Cont. | CMS; provider was contacted |
| CMS Accptd. | total conditions that have been accepted by |
| No Suspect | CMS; condition was not previously a Suspect |
| CMS Total | total of all “CMS accepted” conditions |
| Accptd. Count | |
| Cond. Per | average number of conditions per member |
| Member | |
| Avg. Risk | average risk score per member |
| Factor | |

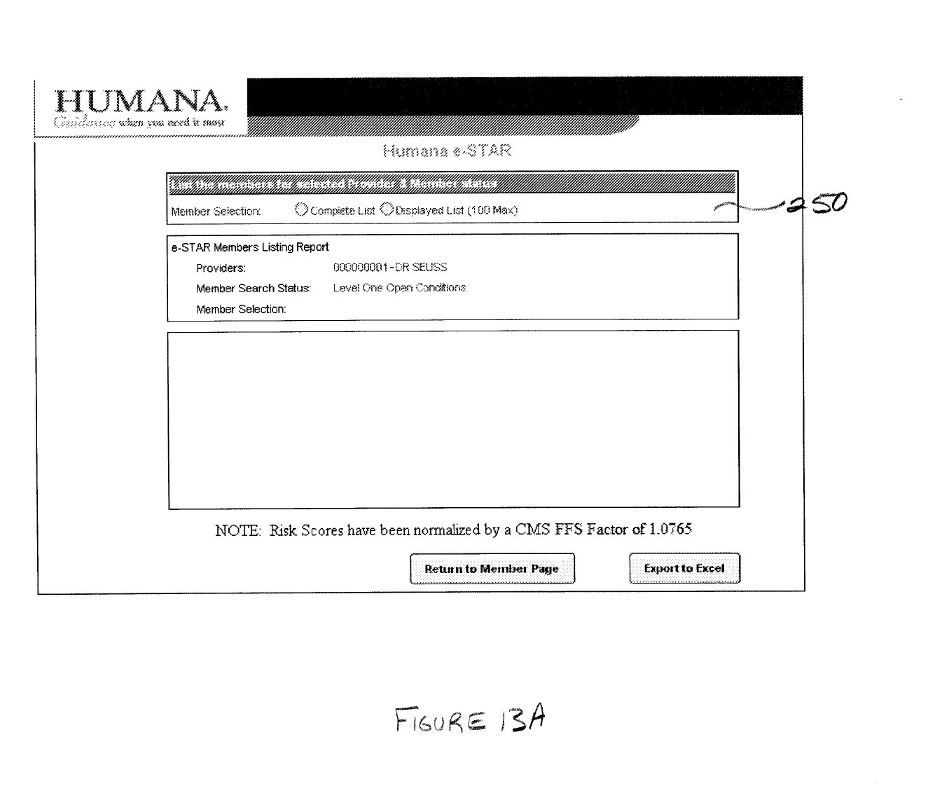

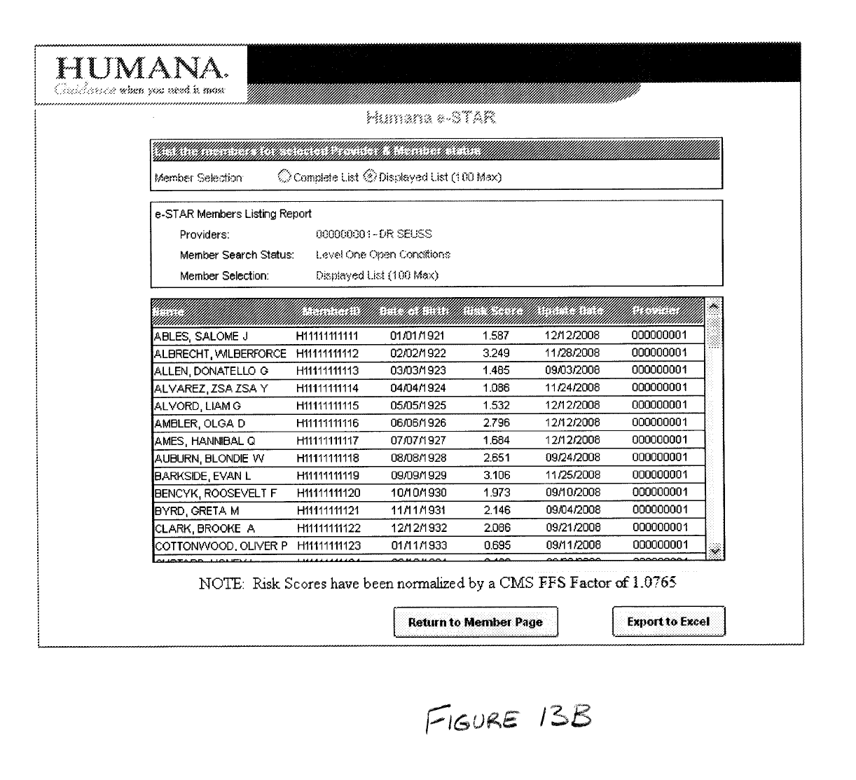

Referring to FIG. 13A, a sample request member listing report page according to an example embodiment is shown. The options on the page provide a user with the ability to display a list of members for which medical records need to be obtained for research. The report data membership is based upon search member status criteria (e.g., members with open conditions, members with affirmed conditions, members with “CMS accepted” conditions, members with conditions and members with no conditions) selected on the main STAR application screen (the member page). There are two available print criteria options for the member listing report 250:

TABLE 6
Member Listing Report Options

| | |
|---|---|
| Complete List | lists entire provider membership for the search member |
| | status criteria selected (includes members not currently |
| | displayed in member list window) |
| Displayed List | lists the provider membership currently displayed in |
| (100 Max) | the member list window for the selected search member |
| | status criteria |

Referring to FIG. 13B, a sample member listing report page according to an example embodiment is shown.

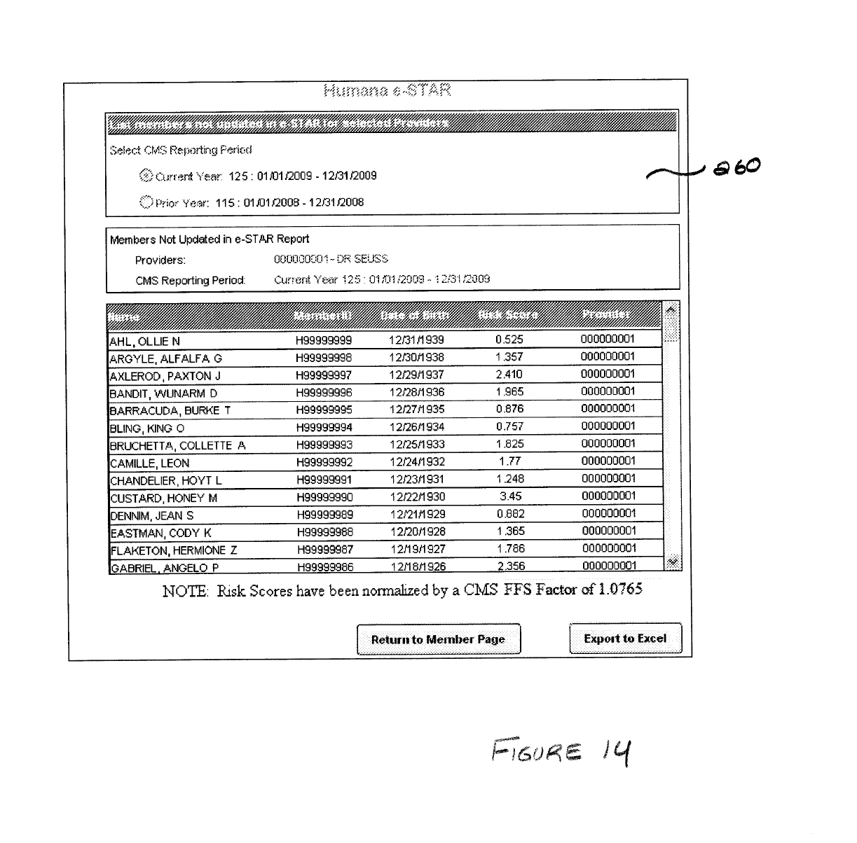

Referring to FIG. 14, a sample “member not updated” report page according to an example embodiment is shown. This report provides the user with the ability to display a list of members that have not been updated (conditions “affirmed” or “denied”) in the STAR database. The report data membership is based upon the provider(s) selected in the provider list window on the main STAR application screen (the member page). There are two available print criteria options for the “members not updated” report 260:

TABLE 7
Members Not Updated Report Options

| | |
|---|---|
| Current Year | lists members with open conditions in the current CMS |
| | period that have not been updated in the STAR database |
| Prior Year | members with open conditions for the previous CMS |
| | reporting period that have not been updated in the STAR |
| | database |

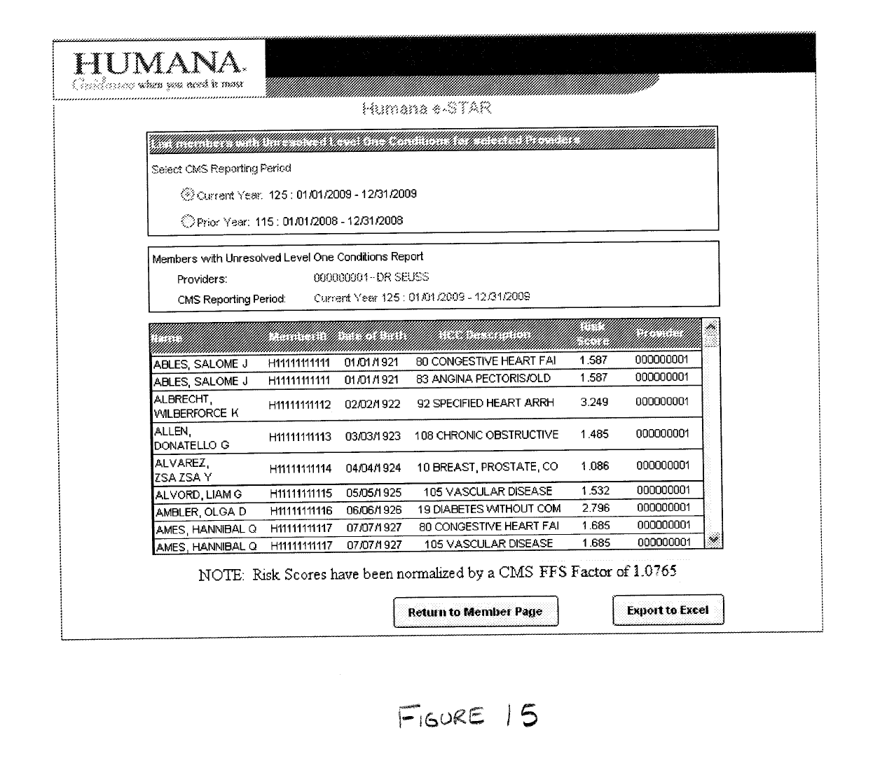

Referring to FIG. 15, a sample “unresolved level one conditions” report according to an example embodiment is shown. This report provides the user with the ability to display a list of members that have open (unresolved) “level one” conditions. Based on the provider(s) selected in the provider list window on the main STAR application screen, this report captures information at a “condition level” of detail. A member having multiple open “level one” conditions appears on this report multiple times with a separate row for each condition. There are two available print criteria options for the Unresolved “level one” report:

TABLE 8
Members with Unresolved “level one” Condition Report Options

| | |
|---|---|
| Current Year | lists members with open “level one” conditions for the |
| | current CMS reporting period |
| Prior Year | lists members with open “level one” conditions for the |
| | previous CMS reporting period |

The computerized system and method of the present disclosure facilitates reimbursements for healthcare services by allowing healthcare providers to access data for members of a health benefits plan and by allowing the healthcare providers to affirm or deny “suspect” health conditions for member records. The affirmation or denial of the presence of various health conditions within the member population along with revised encounter submissions may be used to project reimbursements to the healthcare providers for the services they provide to the members. The computerized system and method facilitates complete and accurate coding of medical records for use in projecting reimbursements to healthcare providers.

While certain embodiments of the present invention are described in detail above, the scope of the invention is not to be considered limited by such disclosure, and modifications are possible without departing from the spirit of the invention as evidenced by the claims. For example, elements of the user interface may be varied and fall within the scope of the claimed invention. Various aspects of data collection and presentation may be varied and fall within the scope of the claimed invention. One skilled in the art would recognize that such modifications are possible without departing from the scope of the claimed invention.

1. A computerized method for coding medical records comprising:
(a) receiving at a computer at least one healthcare claim for a member of a health benefits plan;
(b) processing said at least one healthcare claim to identify a plurality of suspect medical conditions for said member;
(c) adding to a member record for said member at least one medical code for each of said suspect medical conditions identified for said member;
(d) storing in a suspect medical conditions database said member record with said medical codes;
(e) receiving at said computer from a healthcare provider computer user a request to access said member record;
(f) retrieving by said computer from said suspect medical conditions database said member record;
(g) generating by said computer a display comprising:
(1) identifying data for said member;
(2) a list of said medical codes for said suspect medical conditions; and
(3) for each medical code in said list, an affirm option comprising a hyperlink to an affirm condition screen and a deny option;
(h) receiving at said computer from said healthcare provider computer user a request to change an unconfirmed condition status of said medical codes in said list:
(1) by selecting said affirm option to confirm said suspect medical condition at said affirm condition screen; or
(2) by selecting said deny option to deny said suspect medical condition; and
(i) updating by said computer said member record to indicate said healthcare provider confirmation or denial of said medical codes for said suspect medical conditions according to said healthcare provider computer user selection of said affirm option or deny option.

2. The computerized method of claim 1 further comprising:
(j) receiving at said computer from said healthcare provider computer user a request to add a new medical condition to said member record; and
(k) updating at said computer said member record with said new medical condition.

3. The computerized method of claim 2 further comprising (l) updating at said computer said member record to indicate said healthcare provider confirmation of said new medical condition.

4. The computerized method of claim 2 further comprising (l) receiving at said computer a healthcare provider date of service for said new medical condition.

5. The computerized method of claim 1 further comprising:
(j) receiving at said computer a request to generate an activity log from said member record database; and
(k) generating at said computer a list comprising for each of a plurality of member records:
(1) member identifying data;
(2) a medical condition associated with said member record;
(3) a provider status indicator indicating whether a healthcare provider affirmed or denied said medical condition.

6. The computerized method of claim 1 wherein said medical code comprises a description.

7. The computerized method of claim 1 wherein said medical code comprises a numeric code.

8. A computerized system for coding medical records comprising:
(a) a computerized suspect medical conditions database comprising member records for a plurality of members of a health benefits plan, said member records comprising a plurality of medical codes identifying suspect medical conditions that are not confirmed in said member records;
(b) a server executing instructions to:
(1) receive at said server from a healthcare provider computer user a request to access at least one member record from said suspect medical conditions database;
(2) retrieve from said suspect medical conditions database said member record;
(3) generate by said server a display comprising:
(i) identifying data for said member;
(ii) a list of said medical codes for said suspect medical conditions;
(iii) for each medical code in said list, an affirm option comprising
a hyperlink to an affirm condition screen; and
a deny option;
(4) receive at said server from said healthcare provider computer user a request to change said unconfirmed condition status:
(i) by selecting said affirm option to confirm said suspect medical condition at said affirm condition screen; or
(ii) by selecting said deny option to deny said suspect medical condition; and
(5) updating by said server said member record to indicate said healthcare provider confirmation or denial of said medical codes for said suspect medical conditions according to said healthcare provider computer user selection of said affirm option or deny option.

9. The computerized system of claim 8 wherein said server further executes instructions to:
(6) receive at said server from said healthcare provider computer user a request to add a new medical condition to said member record; and
(7) update at said server said member record with said new medical condition.

10. The computerized system of claim 9 wherein said server further executes instructions to (8) update at said server said member record to indicate said healthcare provider confirmation of said new medical condition.

11. The computerized system of claim 9 wherein said server further executes instructions to (8) receive at said server a healthcare provider date of service for said new medical condition.

12. The computerized system of claim 8 wherein said server further executes instructions to:
(6) receive at said server a request to generate an activity log from said suspect medical conditions database; and
(7) generate at said server a list comprising for each of a plurality of member records:
(a) member identifying data;
(b) a suspect medical condition associated with said member record; and
(c) a provider status indicator indicating whether a healthcare provider affirmed or denied said suspect medical condition.

13. The computerized system of claim 8 wherein said suspect medical condition comprises a description.

14. The computerized system of claim 8 wherein said suspect medical condition comprises a numeric code.

15. A computerized method for confirming codes in medical records comprising:
(a) storing in a database member condition profile data for a plurality of members of a health benefits plan;
(b) receiving at a computer from a user computer a request to access at least one member condition profile;
(c) retrieving by said computer from said member condition profile member identifying data for a member and a plurality of health conditions for said member;
(d) identifying by said computer for each of said plurality of health conditions, at least one condition status of provider affirmed or provider denied;
(e) generating for display at said user computer a screen with said member condition profile, said screen comprising:
(1) said member identifying data;
(2) a list of said plurality of health conditions for said member;
(3) for each of said plurality of health conditions in said list, said at least one condition status of provider affirmed or provider denied;
(f) receiving at said computer from said user computer user a selection of an option to change said condition status for at least one of said plurality of medical conditions; and
(g) updating in said database said member condition profile to indicate said change to said condition status for said at least one of said plurality of medical conditions wherein
(i) said changed condition status is provider denied if said condition status was provider affirmed; and
(ii) said changed condition status is provider affirmed if said condition status was provider denied.

16. The computerized method of claim 15 further comprising:
(h) receiving at said computer from said user computer a request to add a new medical condition to said member condition profile; and
(i) updating at said database said member condition profile with said new medical condition.

17. The computerized method of claim 16 further comprising
(j) updating at said database said member condition profile with a healthcare provider confirmation of said new medical condition.

18. The computerized method of claim 17 further comprising
(k) receiving at said computer a healthcare provider date of service for said new medical condition.

19. The computerized method of claim 15 wherein said member condition profile comprises descriptions for said member medical conditions.

20. The computerized method of claim 15 wherein said member condition profile comprises numeric codes for said member medical conditions.
